(19) United States
(12) Patent Application Publication
(10) Pub. No.: US 2021/0337418 A1
(43) Pub. Date: Oct. 28, 2021

(54) ACCESS CATERGORY DETERMINATION FOR LOW LATENCY TRANSMISSION

(71) Applicant: LG Electronics Inc., Seoul (KR)

(72) Inventors: Sanggook KIM, Seoul (KR); Jeongki KIM, Seoul (KR); Jinsoo CHOI, Seoul (KR)

(21) Appl. No.: 17/238,958

(22) Filed: Apr. 23, 2021

Related U.S. Application Data
(60) Provisional application No. 63/014,135, filed on Apr. 23, 2020.

(51) Int. Cl. H04W 28/02; H04W 48/16

(52) U.S. Cl. CPC H04W 28/0236; H04W 28/0273; H04W 48/16; H04W 28/0278; H04W 28/0247

(57) ABSTRACT

A transmitting station (STA) of a wireless local area network (WLAN) system may determine an access category (AC) of a first class traffic. For example, the AC of the first class traffic may be determined as a first AC at a first likelihood. For example, the AC of the first class traffic may be determined as a second AC at a second likelihood. For example, a sum of the first likelihood and the second likelihood may be equal to 1. The transmitting STA may transmit the first class traffic based on the determined AC of the first class traffic. The class for the first traffic may be determined based on at least one of a latency requirement of the first traffic, and a buffer status of the transmitting STA.

### CROSS-REFERENCE TO RELATED APPLICATIONS

Pursuant to 35 U.S.C. § 119 (e), this application claims the benefit of U.S. Provisional Application No. 63/014,135 filed on Apr. 23, 2020, the contents of which are all hereby incorporated by reference herein in their entirety.

### TECHNICAL FIELD

The present specification relates to an access category determination for low latency transmission.

### BACKGROUND

With the fast increase in data transmission rates and the advent of various types of applications, users are now capable of experiencing realistic multimedia environments. Users have already begun to accept new applications providing extreme reality experiences of multimedia environments. And, in the future, such applications are expected to become the main usage applications. For example, such applications include Augmented Reality (AR), Virtual Reality (VR), eXtreme Reality (XR), and so on.

Such applications may provide the users with completely opposite (or contrary) experiences according to latency (latency-sensitive). Mobile communication that is based on the usage of licensed band(s) may allocate a predetermined amount of resource to such application support. Such type of mobile communication may easily use resources. Conversely, in case of an unlicensed band, since all users need to compete with one another in order to use the resource, additional efforts for supporting the application is needed. Most particularly, considering the characteristics of the application, even though sufficient amount of resource is provided to a small number of users, there may occur cases where the users are incapable of using the sufficient amount of resources due to such competition (or contention).

### SUMMARY

The present specification includes a method enabling efficient usage of resources, when supporting an application by using an unlicensed band. A transmitting STA may determine an access category (AC) of a first class traffic. The AC of the first class traffic may be determined as a first AC at a first likelihood and may be determined as a second AC at a second likelihood, and a sum of the first likelihood and the second likelihood may be equal to 1. The transmitting STA may transmit the first class traffic based on the determined AC of the first class traffic.

### ADVANTAGEOUS EFFECTS

According to an example of the present specification, even if an AC for low latency transmission is separately regulated, by allowing an AC to be stochastically selected, a low latency AC may be prevented from occupying the highest priority at all times when performing transmission. Accordingly, other types of traffic may also be given a relatively fair number of transmission opportunities. Most particularly, by using a flexible method that can deterministically support or stochastically support applications by stochastically adjusting a worst-case latency, which is required in low-latency applications, in case the degree of requirement for the worst-case latency is not too demanding, other types of traffic may also be given the opportunity to use the resources. Thus, an advantage of enhancing the overall data transmission throughput may be achieved.

### BRIEF DESCRIPTION OF THE FIGURES

FIG. 1 shows an example of a transmitting apparatus and/or a receiving apparatus according to the present specification.

FIG. 2 is a conceptual diagram of a wireless local area network (WLAN) structure.

FIG. 3 shows a modified example of a transmitting apparatus and/or a receiving apparatus according to the present specification.

FIG. 4 is a diagram showing an operating method of a transmitting STA according to an embodiment of the present specification.

FIG. 5 is a diagram showing an operating method of a receiving STA according to an embodiment of the present specification.

### DETAILED DESCRIPTION

In the present specification, ‘A or B’ may mean ‘only A’, ‘only B’ or ‘both A and B’. In other words, in the present specification, ‘A or B’ may be interpreted as ‘A and/or B’. For example, in the present specification, ‘A, B or C’ may mean ‘only A’, ‘only B’, ‘only C’, or ‘any combination of A, B, and C’.

A slash (/) or comma used in the present specification may mean ‘and/or’. For example, ‘A/B’ may mean ‘A and/or B’. Accordingly, ‘A/B’ may mean ‘only A’, ‘only B’, or ‘both A and B’. For example, ‘A, B, C’ may mean ‘A, B or C’.

In the present specification, ‘at least one of A and B’ may mean ‘only A’, ‘only B’, or ‘both A and B’. In addition, in the present specification, the expression ‘at least one of A or B’ or ‘at least one of A and/or B’ may be interpreted as ‘at least one of A and B’.

In addition, in the present specification, ‘at least one of A, B and C’ may mean ‘only A’, ‘only B’, ‘only C’, or ‘any combination of A, B, and C’. In addition, ‘at least one of A, B or C’ or ‘at least one of A, B and/or C’ may mean ‘at least one of A, B, and C’.

In addition, parentheses used in the present specification may mean ‘for example’. Specifically, when indicated as ‘control information (EHT-Signal)’, it may mean that ‘EHT-Signal’ is proposed as an example of the ‘control information’. In other words, the ‘control information’ of the present specification is not limited to ‘EHT-Signal’, and ‘EHT-Signal’ may be proposed as an example of the ‘control information’. In addition, when indicated as ‘control information (i.e., EHT-Signal)’, it may also mean that ‘EHT-Signal’ is proposed as an example of the ‘control information’.

Technical features described individually in one drawing in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.1 lax standard. Additionally, the present specification may also be applied to the newly proposed EHT standard or IEEE 802.11be standard. Additionally, an example of the present specification may be applied to the EHT standard or a new wireless LAN standard that is an enhanced version of IEEE 802.11be. Additionally, an example of the present specification may be applied to a mobile communication system. For example, it may be applied to a mobile communication system based on Long Term Evolution (LTE) based on the 3rd Generation Partnership Project (3GPP) standard and its evolution. Furthermore, an example of the present specification may be applied to a communication system of a 5G NR standard based on the 3GPP standard.

Hereinafter, in order to describe the technical features of the present specification, the technical features that are applicable to the present specification will be described.

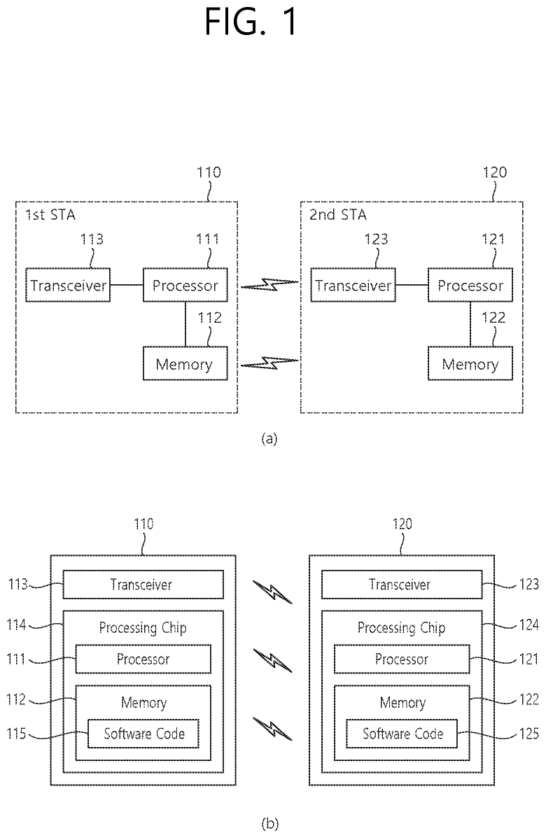

FIG. 1 shows an example of a transmitting apparatus and/or a receiving apparatus according to the present specification.

In the example of FIG. 1, various technical features described below may be performed. FIG. 1 relates to at least one station (STA). For example, STAs (110, 120) of the present specification may also be referred to by using various terms such as a mobile terminal, a wireless device, a wireless transmit/receive unit (WTRU), a user equipment (UE), a mobile station (MS), a mobile subscriber unit, or simply a user. The STAs (110, 120) of the present specification may also be referred to by using various terms such as a network, a base station, a node-B, an access point (AP), a repeater, a router, a relay, and so on. The STAs (110, 120) of the present specification may also be referred to by using various names such as a receiving apparatus, a transmitting apparatus, a receiving STA, a transmitting STA, a receiving device, a transmitting device, and so on.

For example, the STAs (110, 120) may function as an access point (AP) or a non-AP. That is, the STAs (110, 120) of the present specification may perform the functions of an AP and/or a non-AP. In this specification, the AP may also be indicated as an AP STA.

The STAs (110, 120) of the present specification may support various communication standards together in addition to the IEEE 802.11 standard. For example, a communication standard (e.g., LTE, LTE-A, 5G NR standard), or the like, according to the 3GPP standard may be supported. Additionally, the STA of the present specification may be implemented as various devices such as a mobile phone, a vehicle, a personal computer, and so on. Moreover, the STA of the present specification may support communication for various communication services such as voice calls, video calls, data communication, and self-driving (autonomous-driving), and so on. The STAs (110, 120) of the present specification may include a medium access control (MAC) conforming to the IEEE 802.11 standard and a physical layer interface for a wireless (or radio) medium.

The STA (110, 120) will hereinafter be described based on sub-drawing (a) of FIG. 1.

The first STA (110) may include a processor (111), a memory (112), and a transceiver (113). The illustrated process, memory, and transceiver may be implemented individually as separate chips, or at least two blocks/functions may be implemented in a single chip.

The transceiver (113) of the first STA performs a signal transmission/reception operation. Specifically, an IEEE 802.11 packet (e.g., IEEE 802.11a/b/g/n/ac/ax/be, and so on) may be transmitted/received.

For example, the first STA (110) may perform an operation intended by an AP. For example, the processor (111) of the AP may receive a signal through the transceiver (113), process a reception (RX) signal, generate a transmission (TX) signal, and provide control for signal transmission. The memory (112) of the AP may store a signal (e.g., RX signal) received through the transceiver (113), and may store a signal (e.g., TX signal) to be transmitted through the transceiver.

For example, the second STA (120) may perform an operation intended by a non-AP STA. For example, a transceiver (123) of a non-AP performs a signal transmission/reception operation. Specifically, an IEEE 802.11 packet (e.g., IEEE 802.11a/b/g/n/ac/ax/be packet, and so on) may be transmitted/received.

For example, a processor (121) of the non-AP STA may receive a signal through the transceiver (123), process an RX signal, generate a TX signal, and provide control for signal transmission. A memory (122) of the non-AP STA may store a signal (e.g., RX signal) received through the transceiver (123), and may store a signal (e.g., TX signal) to be transmitted through the transceiver.

For example, an operation of an apparatus (or device) indicated as an AP in the specification described below may be performed by the first STA (110) or the second STA (120). For example, if the first STA (110) is the AP, the operation of the apparatus (or device) indicated as the AP may be controlled by the processor (111) of the first STA (110), and a related signal may be transmitted or received through the transceiver (113), which is controlled by the processor (111) of the first STA (110). And, control information related to the operation of the AP or a TX/RX signal of the AP may be stored in the memory (112) of the first STA (110). In addition, if the second STA (120) is the AP, the operation of the apparatus (or device) indicated as the AP may be controlled by the processor (121) of the second STA (120), and a related signal may be transmitted or received through the transceiver (123), which is controlled by the processor (121) of the second STA (120). And, control information related to the operation of the AP or a TX/RX signal of the AP may be stored in the memory (122) of the second STA (120).

For example, in the specification described below, an operation of an apparatus (or device) indicated as a non-AP (or user-STA) may be performed in the first STA (110) or the second STA (120). For example, if the second STA (120) is the non-AP, the operation of the apparatus (or device) indicated as the non-AP may be controlled by the processor (121) of the second STA (120), and a related signal may be transmitted or received through the transceiver (123), which is controlled by the processor (121) of the second STA (120). In addition, control information related to the operation of the non-AP or a TX/RX signal of the non-AP may be stored in the memory (122) of the second STA (120). For example, if the first STA (110) is the non-AP, the operation of the apparatus (or device) indicated as the non-AP may be controlled by the processor (111) of the first STA (110), and a related signal may be transmitted or received through the transceiver (113), which is controlled by the processor (111) of the first STA (110). In addition, control information related to the operation of the non-AP or a TX/RX signal of the non-AP may be stored in the memory (112) of the first STA (110).

In the specification described below, a device (or apparatus) being referred to as a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, and so on, may imply the STAs (110, 120) of FIG. 1. For example, a device (or apparatus) indicated, without any specific reference numeral, as the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, and so on, may imply the STAs (110, 120) of FIG. 1. For example, in the following example, an operation in which various STAs transmit/receive a signal (e.g., a PPDU) may be performed in the transceivers (113, 123) of FIG. 1. In addition, in the following example, an operation in which various STAs generate a TX/RX signal or perform data processing and computation in advance for the TX/RX signal may be performed in the processors (111, 121) of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource), and so on, used for the sub-field (SIG, STF, LTF, Data) included the PPDU; 3) an operation of determining/configuring/obtaining a specific sequence (e.g., a pilot sequence, an STF/LTF sequence, an extra sequence applied to SIG), and so on, used for the sub-field (SIG, STF, LTF, Data) field included in the PPDU; 4) a power control operation and/or power saving operation applied for the STA; and 5) an operation related to determining/obtaining/configuring/decoding/encoding, and so on, of an ACK signal. Additionally, in the following example, a variety of information used by various STAs for determining/obtaining/configuring/computing/decoding/decoding a TX/RX signal (e.g., information related to a field/subfield/control field/parameter/power, and so on) may be stored in the memories (112, 122) of FIG. 1.

The above-described device/STA of sub-drawing (a) of FIG. 1 may be modified as shown in sub-drawing (b) of FIG. 1. Hereinafter, the STA (110, 120) of the present specification will be described based on sub-drawing (b) of FIG. 1.

For example, the transceiver (113, 123) shown in sub-drawing (b) of FIG. 1 may perform the same functions as the transceiver shown in sub-drawing (a) of FIG. 1. For example, a processing chip (114, 124) shown in sub-drawing (b) of FIG. 1 may include a processor (111, 121) and a memory (112, 122). The processor (111, 121) and the memory (112, 122) shown in sub-drawing (b) of FIG. 1 may perform the same functions as the processor (111, 121) and the memory (112, 122) shown in the above-described sub-drawing (a) of FIG. 1.

In the specification described below, a mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving device, a transmitting device, a receiving STA, a transmitting STA, a receiving apparatus, and/or a transmitting apparatus may mean an STA (110, 120) shown in sub-drawings (a)(b) of FIG. 1, or may mean a processing chip (114, 124) shown in sub-drawing (b) of FIG. 1. For example, the technical feature of the transmitting STA transmitting a control signal may be understood as a technical feature of a control signal, which is generated in the processor (111, 121) shown in sub-drawings (a)/(b) of FIG. 1, being transmitted through the transceiver (113, 123) shown in sub-drawings (a)/(b) of FIG. 1. Alternatively, the technical feature of the transmitting STA transmitting a control signal may be understood as a technical feature of a control signal, which is to be delivered (or transported) to the transceiver (113, 123), being generated in the processing chip (114, 124) shown in sub-drawing (b) of FIG. 1.

For example, the technical feature of the receiving STA receiving a control signal may be understood as a technical feature of a control signal being received by the transceiver (113, 123) shown in sub-drawing (a) of FIG. 1. Alternatively, the technical feature of the receiving STA receiving a control signal may be understood as a technical feature of a control signal, which is received by the transceiver (113, 123) shown in sub-drawing (a) of FIG. 1, being obtained by the processor (111, 121) shown in sub-drawing (a) of FIG. 1. Alternatively, the technical feature of the receiving STA receiving a control signal may be understood as a technical feature of a control signal, which is received by the transceiver (113, 123) shown in sub-drawing (b) of FIG. 1, being obtained by the processing chip (114, 124) shown in sub-drawing (b) of FIG. 1.

Referring to sub-drawing (b) of FIG. 1, a software code (115, 125) may be included in the memory (112, 122). The software code (115, 125) may include instructions controlling the operations of the processor (111, 121). The software code (115, 125) may be included in various programming languages.

The processor (111, 121) or processing chip (114, 124) shown in FIG. 1 may include application-specific integrated circuit (ASIC), other chipset, logic circuit and/or data processing device. The processor (610) may be an application processor (AP). For example, the processor (111, 121) or processing chip (114, 124) shown in FIG. 1 may include at least one of a digital signal processor (DSP), a central processing unit (CPU), a graphics processing unit (GPU), a modem (modulator and demodulator). For example, the processor (111, 121) or processing chip (114, 124) shown in FIG. 1 may be found in SNAPDRAGONT™ series of processors made by Qualcomm®, EXYNOS™ series of processors made by Samsung®, a series of processors made by Apple®, HELIO™ series of processors made by MediaTek®, ATOM™ series of processors made by Intel®, or may be an enhanced version of such processor(s) (or a corresponding next generation processor).

In the present specification, an uplink may mean a link that is established for a communication from a non-AP STA to an AP STA. And, an uplink PPDU/packet/signal, and so on, may be transmitted through the uplink. Additionally, in the present specification, a downlink may mean a link that is established for a communication from an AP STA to a non-AP STA. And, a downlink PPDU/packet/signal, and so on, may be transmitted through the downlink.

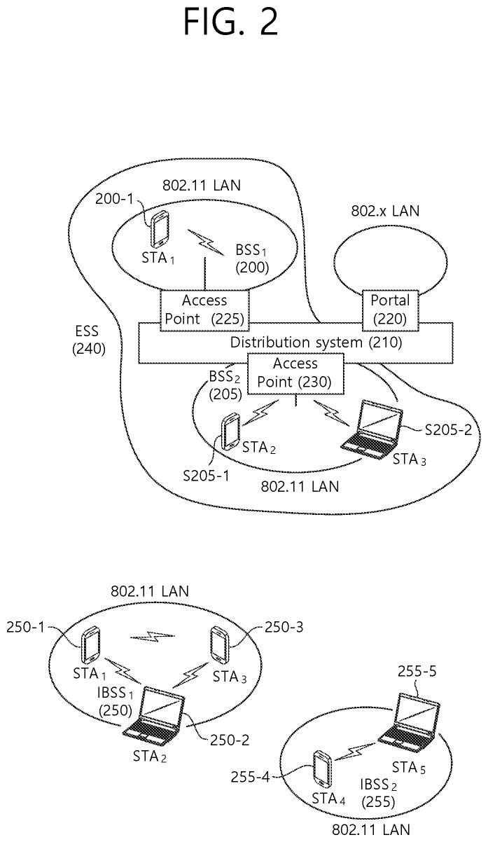

FIG. 2 is a conceptual diagram of a wireless local area network (WLAN) structure.

An upper part of FIG. 2 illustrates the structure of an infrastructure basic service set (BSS) of institute of electrical and electronic engineers (IEEE) 802.11.

Referring to the upper part of FIG. 2, the wireless LAN system may include one or more infrastructure BSSs (200, 205) (hereinafter, referred to as BSS). As a set of an AP and an STA, such as an access point (AP) (225) and a station (STA1) (200-1), which are successfully synchronized to communicate with each other, the BSSs (200, 205) are not concepts indicating a specific region. The BSS (205) may include one or more STAs (205-1, 205-2), which may be coupled with one AP (230).

The BSS may include at least one STA, APs providing a distribution service, and a distribution system (DS) (210) connecting multiple APs.

The distribution system (210) may implement an extended service set (ESS)(240), which is extended by connecting multiple BSSs (200, 205). The ESS (240) may be used as a term for indicating one network that is configured by connecting one or more APs through the distribution system (210). The AP being included in one ESS (240) may have the same service set identification (SSID).

A portal (220) may function as a bridge, which connects the wireless LAN network (IEEE 802.11) and another network (e.g., 802.X).

In the BSS shown in the upper part of FIG. 2, a network between the APs (225, 230) and a network between the APs (225, 230) and the STAs (200-1, 205-1, 205-2) may be implemented. However, it may also be possible to perform communication by configuring a network even between the STAs without the APs (225, 230). A network performing communication by configuring a network even between the STAs without the APs (225, 230) is defined as an Ad-Hoc network or an independent basic service set (IBSS).

A lower part of FIG. 2 illustrates a conceptual diagram showing the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs (250-1, 250-2, 250-3, 255-4, 255-5) are managed in a distributed manner. In the IBSS, all STAs (250-1, 250-2, 250-3, 255-4, 255-5) may be configured as movable STAs. And, since the STAs are not authorized (or allowed) to access the DS, they configure a self-contained network.

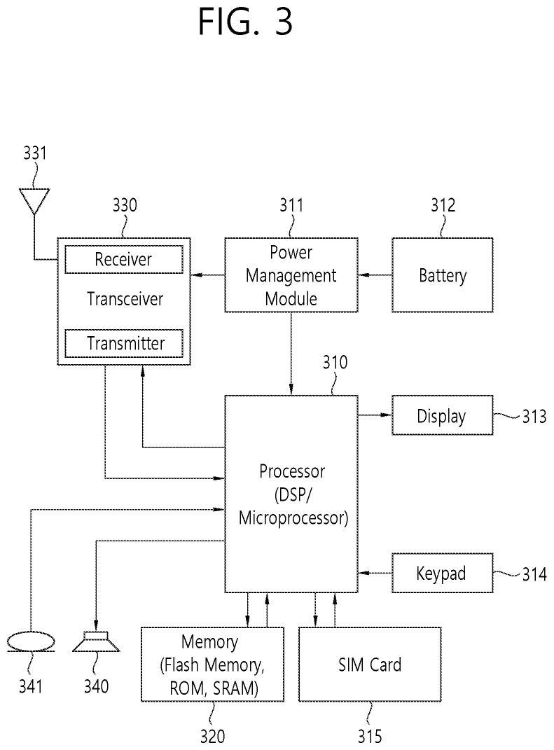

FIG. 3 shows a modified example of a transmitting apparatus and/or a receiving apparatus according to the present specification.

Each apparatus (or device)/STA shown in sub-drawings (a)/(b) of FIG. 1 may be modified as shown in FIG. 3. A transceiver (330) of FIG. 3 may be the same as the transceiver (113, 123) of FIG. 1. The transceiver (330) of FIG. 3 may include a receiver and a transmitter.

A processor (310) of FIG. 3 may be the same as the processor (111, 121) of FIG. 1. Alternatively, the processor (310) of FIG. 3 may be the same as the processing chip (114, 124) of FIG. 1.

A memory (150) of FIG. 3 may be the same as the memory (112, 122) of FIG. 1. Alternatively, the memory (150) of FIG. 3 may be a separate external memory, which is different from the memory (112, 122) of FIG. 1.

Referring to FIG. 3, a power management module (311) manages power for the processor (310) and/or the transceiver (330). A battery (312) supplies power to the power management module (311). A display (313) outputs processing results performed by the processor (310). A keypad (314) receives input that is to be used by the processor (310). The keypad (314) may be indicated (or displayed) on the display (313). A SIM card (315) is an integrated circuit that is intended to securely store the international mobile subscriber identity (IMSI) number and its related key, which are used to identify and authenticate subscribers on mobile telephony devices (such as mobile phones and computers).

Referring to FIG. 3, a speaker (340) outputs sound-related results processed by the processor (310). A microphone (341) receives sound-related inputs to be used by the processor (310).

For radio access that is used in the present specification, the most representative (or typical) access methods, such as Wi-Fi (i.e., wireless local area network (WLAN)), Bluetooth Low Energy (BLE), Ultra-Wideband (UWB), and so on, may all be applied.

As a representative (or typical) type of unlicensed band communication, Wi-Fi may support different Quality of Service (QoS) requirements of each application through an access category (AC). An AC provides an application, which requires low latency, with faster processing by differentiating channel access opportunities that may be selected during contention.

Table 1 shown below indicates Default Parameter values corresponding to each AC defined in IEEE802.11e.

TABLE 1
Default EDCA Parameters for each AC

| AC | CWmin | CWmax | AIFSN | Max TXOP |
|---|---|---|---|---|
| Background | 15 | 1023 | 7 | 0 |
| (AC_BK) | | | | |
| Best Effort | 15 | 1023 | 3 | 0 |
| (AC_BE) | | | | |
| Video (AC_VI) | 7 | 15 | 2 | 3.008 ms |
| Voice (AC_VO) | 3 | 7 | 2 | 1.504 ms |
| Legacy DCF | 15 | 1023 | 2 | 0 |

When conflict occurs, each AC may re-attempt channel access by changing its value, which may be selected starting from Contention Window minimum (CW min) to Contention Window maximum (CW max). That is, when a UE performs EDCA, a CW size may vary according to the AC, and, based on a random value taken from the CW, the UE may perform back-off.

A new access category may be defined, or an existing access category may be used for a latency-sensitive application (or traffic). That is, an access category for low-latency traffic (i.e., latency-sensitive traffic) may be newly defined. Low-latency traffic, which will hereinafter be described, may mean traffic being sensitive to latency, i.e., traffic requiring low latency, or traffic being abandoned if latency occurs for a threshold time period or more, or traffic that needs to be transmitted within a short latency period.

A Fallback AC and a Default AC may be allocated to an application (or traffic). For example, in case of using the existing AC, AC_VI may be allocated as the Fallback AC, and AC_VO may be allocated as the Default AC. When a new access category is defined, two or more ACs may be allocated to one application (or traffic). The allocated two or more access categories may also be a combination of a newly defined AC and existing ACs. Additionally, an application (or traffic) may be classified into different Classes according to the required latency and performance. For example, VR, which requires ultra-low latency and low transmission error, may be categorized in advance as Class 0, Real-Time Streaming Video may be categorized in advance as Class 2, and so on.

For example, since Class 0 requires the lowest latency, an AC for low-latency traffic (hereinafter, AC_LL) may be allocated as the Default AC, and AC_VO may be allocated as the Fallback AC. Therefore, the traffic of Class 0 may be determined as one of AC_LL and AC_VO.

An access point (AP) managing a Base Service Set (BSS) may broadcast, multicast, and/or unicast Fallback and Default ACs according to the class of each application (or traffic).

An AP may simultaneously support multiple links (e.g., Multi-Link Device AP (MLD AP)). That is, an MLD AP may include multiple APs. Additionally, an STA accessing the AP may simultaneously support multiple links (e.g., Multi-Link Device STA (MLD STA) or Multi-Link Device non-AP (MLD non-AP)). That is, a non-AP STA MLD may include multiple STAs.

Fallback and Default AC information according to the class of each application (or traffic) may be included in Beacon, Probe response, (Re-)Association response frames. The Fallback and Default AC information according to the class of each application (or traffic) may be included in an existing Information element or a newly defined Information element, or in a field, subfield value within the corresponding element. For example, the Fallback and Default AC information according to the class of each application (or traffic) may be included in an Operation element, a new Parameter element, and so on.

A value between 0 and 1 may be allocated to the AC (Fallback, Default). For example, this value may be interpreted as likelihood. For example, 0.2 may be allocated to the Fallback AC, and 0.8 may be allocated to the Default AC, and the sum of the two values allocated to each of the Fallback AC and the Default AC is equal to 1. For example, between the two values being allocated to both ACs (i.e., Fallback AC and Default AC), the larger value and its corresponding AC may be specified. That is, since the sum of the larger value and the smaller value is always equal to 1, only the larger value may be indicated.

For example, these values (i.e., selection likelihood per AC) may be determined according to a number of STAs requiring latency-sensitivity and a number of legacy STAs, which are all currently being processed by the AP within the BSS. Additionally, the likelihood value may be determined by also considering a currently available remaining amount of resource. The likelihood value may vary consistently, and the varied likelihood value may be delivered to the STA periodically or aperiodically.

### Operation Example 1

In a BSS managed by the AP, 2 STAs operating 2 applications may exist. One application may be Real-Time Video Streaming (Class 2), and another application may be Virtual Reality (Class 0). The AP may deliver the following parameters to the STAs.

Class 0: Fallback AC=AC_VI, Likelihood 0.1, Default AC=AC_VO Likelihood 0.9

Class 2: Fallback AC=AC_VI Likelihood 0.9, Default AC=AC_VO Likelihood 0.1

For example, in case of Real-Time Video Streaming, AC_VO may be determined as the AC at a likelihood of 10%, and AC_VI may be determined as the AC at a likelihood of 90%. Each application may access a channel according to the selected AC and may then transmit each packet. Such selection may be differently performed for each packet, or may be applied to a predetermined number of packet digits, or may be maintained until a session is ended. That is, an STA (or AP) may newly select an AC corresponding to a Class each time a packet is transmitted, or may newly select an AC corresponding to a Class each time a predetermined number of packets are transmitted, or may newly select an AC corresponding to a Class for each session.

For example, an instance where the Default AC is selected and an instance where the Fallback AC is selected may be independently performed. In this case, the sum of the likelihood of selecting the Fallback AC and the likelihood of selecting the Default AC does not need to be equal to 1. In this case, the Default AC and the Fallback AC may both be selected, or both ACs may not be selected. When selecting a transmission AC according to the likelihood, in case both ACs are selected, the transmission may be performed based on the AC having the higher likelihood, or the transmission may be performed based on the AC having the lower likelihood. Alternatively, a transmission AC may be selected, by generally considering the usage situation of both ACs up to the current time point of the application, which is currently being used. This operation may be delivered to the STA in accordance with the determination (or decision) of the AP, or may be carried out in accordance with the determination (or decision) of the STA itself.

### Operation Example 2

In a BSS managed by the AP, 2 STAs operating 2 applications may exist. Both applications may be Virtual Reality (Class 0). The AP may deliver the following parameters to the STAs.

Class 0: Fallback AC=AC_VI, Likelihood 0.1, Default AC=AC_VO, Likelihood 0.9

For example, in case of Virtual Reality, AC_VI may be determined as the AC at a likelihood of 10%, and AC_VO may be determined as the AC at a likelihood of 90%. Each application may access a channel according to the selected AC and may then transmit each packet. Such selection may be differently performed for each packet, or may be applied to a predetermined number of packet digits, or may be maintained until a session is ended. That is, an STA (or AP) may newly select an AC corresponding to a Class each time a packet is transmitted, or may newly select an AC corresponding to a Class each time a predetermined number of packets are transmitted, or may newly select an AC corresponding to a Class for each session.

Even the same application may be assigned with an opportunity to select a different AC. Therefore, by distributing repetition of conflict, which may persistently occur each time a conflict occurs at an attempt to perform access, this operation may have an effect of enhancing system throughput.

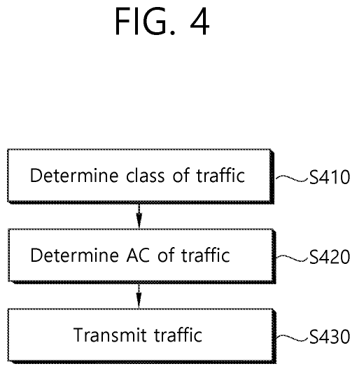

FIG. 4 is a diagram showing an operating method of a transmitting STA according to an embodiment of the present specification.

Referring to FIG. 4, a transmitting STA may determine a class of a traffic (S410). For example, the transmitting STA may determine a class for a first traffic. For example, the class for the first traffic may be determined based on at least one of a latency requirement of the first traffic, and a buffer status of the transmitting STA.

The transmitting STA may determine an AC of the traffic (S420). For example, the transmitting STA may determine an access category (AC) of the first class traffic. For example, the AC of the first class traffic may be determined as a first AC at a first likelihood and may be determined as a second AC at a second likelihood. And, herein, the sum of the first likelihood and the second likelihood may be equal to 1.

The transmitting STA may transmit a traffic (S430). For example, the transmitting STA may transmit the first class traffic based on the determined AC of the first class traffic.

For example, the first AC may be an access category for low latency traffic. And, the low latency traffic may be a traffic that shall be transmitted within a threshold time.

For example, the second AC may be an access category for audio traffic.

For example, after the first class traffic determines its AC as one of the first AC and the second AC, if the first class traffic is transmitted as much as a predetermined number of packets, the AC of the first class traffic may once again be determined as the first AC at the first likelihood and may be determined as the second AC at the second likelihood.

For example, the transmitting STA determines an AC of a second class traffic. And, herein, the AC of the second class traffic may be determined as a first AC at a third likelihood and may be determined as a second AC at a fourth likelihood. And, herein, the sum of the third likelihood and the fourth likelihood may be equal to 1.

For example, the first likelihood may be determined based on at least one of a latency requirement of the first class traffic, a buffer status of the transmitting STA, and a number of transmission sessions performed based on an access category for the low latency traffic during a predetermined time duration.

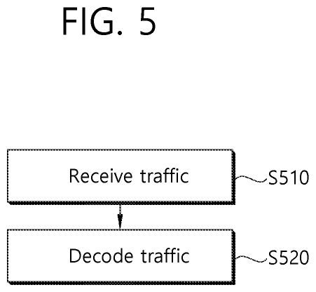

FIG. 5 is a diagram showing an operating method of a receiving STA according to an embodiment of the present specification.

Referring to FIG. 5, a receiving STA may receive traffic (S510). The receiving STA may decode the traffic (S520).

Among the detailed process steps indicated in the examples of FIG. 4 and FIG. 5, some steps may not be necessary steps and may, therefore, be omitted. Other process steps other than the process steps shown in FIG. 4 and FIG. 5 may be added, and the order of the process steps may also change. Among the process steps, some steps may have independent technical meanings.

The technical features of the above-described present specification may be applied to various apparatus (or devices) and methods. For example, the technical features of the above-described present specification may be performed/supported by the apparatus (or device) of FIG. 1 and/or FIG. 3. For example, the technical features of the above-described present specification may be applied only to part of FIG. 1 and/or FIG. 3. For example, the technical features of the above-described present specification may be implemented based the processing chip (114, 124) of FIG. 1, or may be implemented based on the processor (111, 121) and the memory (112, 122) of FIG. 1, or may be implemented based on the processor (310) and the memory (320) of FIG. 3.

The technical features of the above-described present specification may be implemented based on a computer readable medium (CRM). For example, the CRM that is proposed in the present specification, which is at least one computer readable medium including an instruction being executed by at least one processor of an station (STA) in a wireless local area network (WLAN) system, may include an instruction performing an operation including the steps of determining an access category (AC) of a first class traffic, wherein the AC of the first class traffic is determined as a first AC at a first likelihood and determined as a second AC at a second likelihood, and wherein a sum of the first likelihood and the second likelihood is equal to 1, and transmitting the first class traffic based on the determined AC of the first class traffic.

An instruction being stored in a CRM of the present specification may be executed by at least one processor. The at least one processor related to the CRM of the present specification may be the processor (111, 121) or the processing chip (114, 124) of FIG. 1, or the processor (310) of FIG. 3. Meanwhile, the CRM of the present specification may be the memory (112, 122) of FIG. 1 or the memory (320) of FIG. 3, or a separate external memory/storage medium/disc, and so on.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims specified in the present specification may be combined by various methods. For example, technical features of the method claim(s) of the present specification may be combined so as to be implemented as a device (or apparatus), and technical features of the device claim(s) may be combined so as to be implemented as a method. Additionally, technical features of the method claim(s) of the present specification and technical features of the device claim(s) may be combined so as to be implemented as a device (or apparatus), and technical features of the method claim(s) of the present specification and technical features of the device claim(s) may be combined so as to be implemented as a method.

What is claimed is:

1. A method performed by a transmitting station (STA) of a wireless local area network (WLAN) system, comprising:
determining an access category (AC) of a first class traffic, wherein the AC of the first class traffic is determined as a first AC at a first likelihood and determined as a second AC at a second likelihood, and wherein a sum of the first likelihood and the second likelihood is equal to 1; and
transmitting the first class traffic based on the determined AC of the first class traffic.

2. The method of claim 1, wherein the first AC is an access category for low latency traffic, and
wherein the low latency traffic is a traffic that is required to be transmitted within a threshold time.

3. The method of claim 1, wherein the second AC is an access category for audio traffic.

4. The method of claim 1, wherein, after the first class traffic determines its AC as one of the first AC and the second AC, and if the first class traffic is transmitted as much as a predetermined number of packets, the AC of the first class traffic is once again determined as the first AC at the first likelihood and determined as the second AC at the second likelihood.

5. The method of claim 1, further comprising:
determining an AC of a second class traffic,
wherein the AC of the second class traffic is determined as a first AC at a third likelihood and as a second AC at a fourth likelihood, and wherein a sum of the third likelihood and the fourth likelihood is equal to 1.

6. The method of claim 2, wherein the first likelihood is determined based on at least one of a latency requirement of the first class traffic, a buffer status of the transmitting STA, and a number of transmission sessions performed based on an access category for the low latency traffic during a predetermined time duration.

7. The method of claim 1, further comprising:
determining a class for a first traffic,
wherein the class for the first traffic is determined based on at least one of a latency requirement of the first traffic, and a buffer status of the transmitting STA.

8. A transmitting station (STA) of a wireless local area network (WLAN) system, comprising:
a transceiver transmitting/receiving radio signals; and
a processor being operatively connected to the transceiver,
wherein the processor is configured to:
determine an access category (AC) of a first class traffic, wherein the AC of the first class traffic is determined as a first AC at a first likelihood and determined as a second AC at a second likelihood, and wherein a sum of the first likelihood and the second likelihood is equal to 1, and
transmit the first class traffic based on the determined AC of the first class traffic.

9. The transmitting STA of claim 8, wherein the first AC is an access category for low latency traffic, and
wherein the low latency traffic is a traffic that is required to be transmitted within a threshold time.

10. The transmitting STA of claim 8, wherein the second AC is an access category for audio traffic.

11. The transmitting STA of claim 8, wherein, after the first class traffic determines its AC as one of the first AC and the second AC, and if the first class traffic is transmitted as much as a predetermined number of packets, the AC of the first class traffic is once again determined as the first AC at the first likelihood and determined as the second AC at the second likelihood.

12. The transmitting STA of claim 8, wherein the processor is further configured to:
determine an AC of a second class traffic,
wherein the AC of the second class traffic is determined as a first AC at a third likelihood and as a second AC at a fourth likelihood, and wherein a sum of the third likelihood and the fourth likelihood is equal to 1.

13. The transmitting STA of claim 9, wherein the first likelihood is determined based on at least one of a latency requirement of the first class traffic, a buffer status of the transmitting STA, and a number of transmission sessions performed based on an access category for the low latency traffic during a predetermined time duration.

14. The transmitting STA of claim 8, wherein the processor is further configured to:
determine a class for a first traffic,
wherein the class for the first traffic is determined based on at least one of a latency requirement of the first traffic, and a buffer status of the transmitting STA.

15. A computer readable medium including an instruction being executed by at least one processor, and performing an operation comprising the steps of:
determining an access category (AC) of a first class traffic, wherein the AC of the first class traffic is determined as a first AC at a first likelihood and determined as a second AC at a second likelihood, and wherein a sum of the first likelihood and the second likelihood is equal to 1; and
transmitting the first class traffic based on the determined AC of the first class traffic.
